(19) United States
(12) Patent Application Publication
(10) Pub. No.: US 2011/0145274 A1
(43) Pub. Date: Jun. 16, 2011

(54) Exemplary Data Guidance in a Multi-Modality Data Viewer

(75) Inventors: Gopal Avinash, Menomonee Falls, WI (US); Chetan Hd, Bangalore (IN); Arun Kumar Chandrashekarappa, Bangalore (IN); Arvind Kumar, Bangalore (IN); Raja Shekhara, Bangaloare (IN)

(73) Assignee: GENERAL ELECTRIC COMPANY, Schenectady, NY (US)

(21) Appl. No.: 12/639,648

(22) Filed: Dec. 16, 2009

(51) Int. Cl. G06F 17/30; G06F 3/048

(52) U.S. Cl. 707/769; 707/E17.005; 707/E17.014; 715/838; 707/802; 707/E17.044

(57) ABSTRACT

Systems, methods and mediums with instructions for viewing medical data are provided. A system for viewing medical data can include a computer processor, a database and a user interface. The database can include numerous entries from numerous clinical modalities. Each entry can include image data and/or non-image data. Each entry can include annotated medical information from a previous study. The annotated medical information can include comments and markings. The database can be searchable to identify an entry based on input medical information relating to a current study. The user interface can be configured to simultaneously display annotated medical information from an identified entry and medical information from the current study. The system can further include a second user interface configured to display medical information, allow a user to annotate the medical information, and allow the user to save the annotated medical information as an entry in the database.

### RELATED APPLICATIONS

[Not Applicable]

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

Medical diagnostics is currently limited by the availability of specialists in any given field (for example, specializing in Diagnostic Radiology, Vascular & Interventional Radiology, Clinical Magnetic Resonance, Nuclear Medicine, Musculoskeletal Radiology, pathology, or cardiology). A specialist may be needed to review images and/or non-image data in connection with diagnosing a medical condition. In certain instances, numerous specialists may be needed to provide analysis in order to come up with a single diagnosis. However, the number of specialists available is far fewer than the number of individual's requiring medical attention.

Further, historical knowledge such as data from previous exams may be available to a specialist, but not to other practitioners. For example, specialized departments often maintain databases that include data from previous exams. However, such databases may not be accessible to those outside the department. Also, previous exams may be segregated by clinical modality (for example, cardiology, oncology, muscleoskeletal, urology, neurology, etc.), imaging modality (for example, Computed Tomography (CT), Magnetic Resonance (MR), Nuclear Medical (NM), X-ray, Ultrasound, etc.), and/or pathology (for example, tuberculin-skin test, sputum smear culture, etc.).

Thus, there is a need to improve the availability of specialized knowledge that can be used in diagnosing medical conditions.

### BRIEF SUMMARY OF THE INVENTION

Certain embodiments of the present technology provide systems, methods and computer-readable storage mediums encoded with instructions that can be used in connection with diagnosing medical conditions. For example, a system for viewing medical data can include: a computer processor operably connected to a database and a user interface, the database including a plurality of entries from a plurality of clinical modalities, each entry including at least one of image data and a non-image data, each entry including annotated medical information from a previous study, the annotated medical information including at least one of comments and markings, the database searchable to identify an entry based on input medical information relating to a current study, and the user interface configured to simultaneously display annotated medical information from an identified entry and medical information from the current study.

In certain embodiments, the system can further include a second user interface operably connected to the processor and the database, the second user interface configured to display medical information from a study, allow a user to annotate the medical information, and allow the user to save the annotated medical information as an entry in the database.

In certain embodiments, the second user interface can be configured to allow a user to classify the study with a category and a sub-category.

In certain embodiments, the second user interface can be configured to allow a user to classify the study as normal or abnormal.

In certain embodiments, the input medical information can be a category and a sub-category.

In certain embodiments, the user interface can be configured to display a plurality of thumbnails associated with other database entries that are also identified based on the input medical information.

In certain embodiments, the displayed annotated medical information can include a database entry classified as normal and a database entry classified as abnormal.

In certain embodiments, the displayed annotated medical information can include a database entry classified as a first clinical modality and a database entry classified as a second clinical modality, wherein both entries include both image data and non-image data.

In certain embodiments, a method for viewing medical data can include: inputting medical information relating to a current study; using a computer processor to search a database including a plurality of entries from a plurality of clinical modalities to identify an entry based on the input medical information, each entry including at least one of image data and a non-image data, each entry including annotated medical information from a previous study, the annotated medical information including at least one of comments and markings; and using a user interface to simultaneously display annotated medical information from an identified entry and medical information from the current study.

In certain embodiments, the method can further include using a second user interface operably connected to the processor and the database to display medical information from a study, allow annotation of the medical information, and allow the annotated medical information to be saved as an entry in the database.

In certain embodiments, the second user interface can be configured to allow a user to classify the study with a category and a sub-category.

In certain embodiments, the second user interface can be configured to allow a user to classify the study as normal or abnormal.

In certain embodiments, the input medical information can be a category and a sub-category.

In certain embodiments, the user interface can be configured to display a plurality of thumbnails associated with other database entries that are also identified based on the input medical information.

In certain embodiments, the displayed annotated medical information can include a database entry classified as normal and a database entry classified as abnormal.

In certain embodiments, the displayed annotated medical information can include a database entry classified as a first clinical modality and a database entry classified as a second clinical modality, wherein both entries include both image data and non-image data.

In certain embodiments, a computer-readable storage medium encoded with a set of instructions for execution on a processing device and associated processing logic can include the following instructions: a first routine configured to allow medical information relating to a current study to be input; a second routine configured to allow a database including a plurality of entries from a plurality of clinical modalities to be searched to identify an entry based on the input medical information, each entry including image data and a non-image data, each entry including annotated medical information from a previous study, the annotated medical information including comments and markings; and a third routine configured to provide for simultaneous display of annotated medical information from an identified entry and medical information from the current study.

In certain embodiments, the computer-readable storage medium encoded with a set of instructions can further include: a fourth routine configured to provide for display of medical information; a fifth routine configured to allow annotation of the medical information; and a sixth routine configured to allow the annotated medical information to be saved as an entry in the database.

In certain embodiments, the computer-readable storage medium encoded with a set of instructions can further include: a seventh routine configured to allow classification of the entry with a category and a sub-category.

In certain embodiments, the computer-readable storage medium encoded with a set of instructions can further include: an eighth routine configured to allow classification of the entry as normal or abnormal.

In certain embodiments, the input medical information can be a category and a sub-category.

In certain embodiments, the third routine can be configured to provide for display of a plurality of thumbnails associated with other database entries that are also identified based on the input medical information.

In certain embodiments, the third routine can be configured to provide for display of annotated information from a database entry classified as normal and annotated information from a database entry classified as abnormal.

In certain embodiments, the third routine can be configured to provide for display of annotated information from a database entry classified as a first clinical modality and a database entry classified as a second clinical modality, wherein both entries include both image data and non-image data.

### BRIEF DESCRIPTION OF THE DRAWINGS

FIG. 1 depicts a medical data viewing system used in accordance with embodiments of the present technology.

FIG. 2 depicts a portion of a user interface used in accordance with embodiments of the present technology.

FIG. 3 depicts a portion of a user interface used in accordance with embodiments of the present technology.

FIG. 4 depicts a user interface used in accordance with embodiments of the present technology.

FIG. 5 depicts a user interface used in accordance with embodiments of the present technology.

FIG. 6A depicts an annotated image used in accordance with embodiments of the present technology.

FIG. 6B depicts an annotated image used in accordance with embodiments of the present technology.

FIG. 7 depicts an annotated image used in accordance with embodiments of the present technology.

FIG. 8 depicts annotated test results used in accordance with embodiments of the present technology.

FIG. 9 depicts a database entry classification table used in accordance with embodiments of the present technology.

FIG. 10 provides types of database entry classification data used in accordance with embodiments of the present technology.

FIG. 11 depicts an example of a diagnosis workflow.

FIG. 12 depicts a flow chart for a medical data viewing method used in accordance with embodiments of the present technology.

FIG. 13 depicts a clinical information system used in accordance with embodiments of the present technology.

The foregoing summary, as well as the following detailed description of embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF CERTAIN EMBODIMENTS

Certain embodiments of the present technology provide systems, methods and computer-readable storage mediums encoded with instructions that can be used in connection with diagnosing medical conditions. Certain embodiments are described below. While the described embodiments refer to specific clinical modalities, imaging modalities and/or pathologies, one skilled in the art will appreciate that the teachings herein can be applied across the full spectrum of medical departments, modalities and pathologies. In the figures, like elements are identified with like indicators.

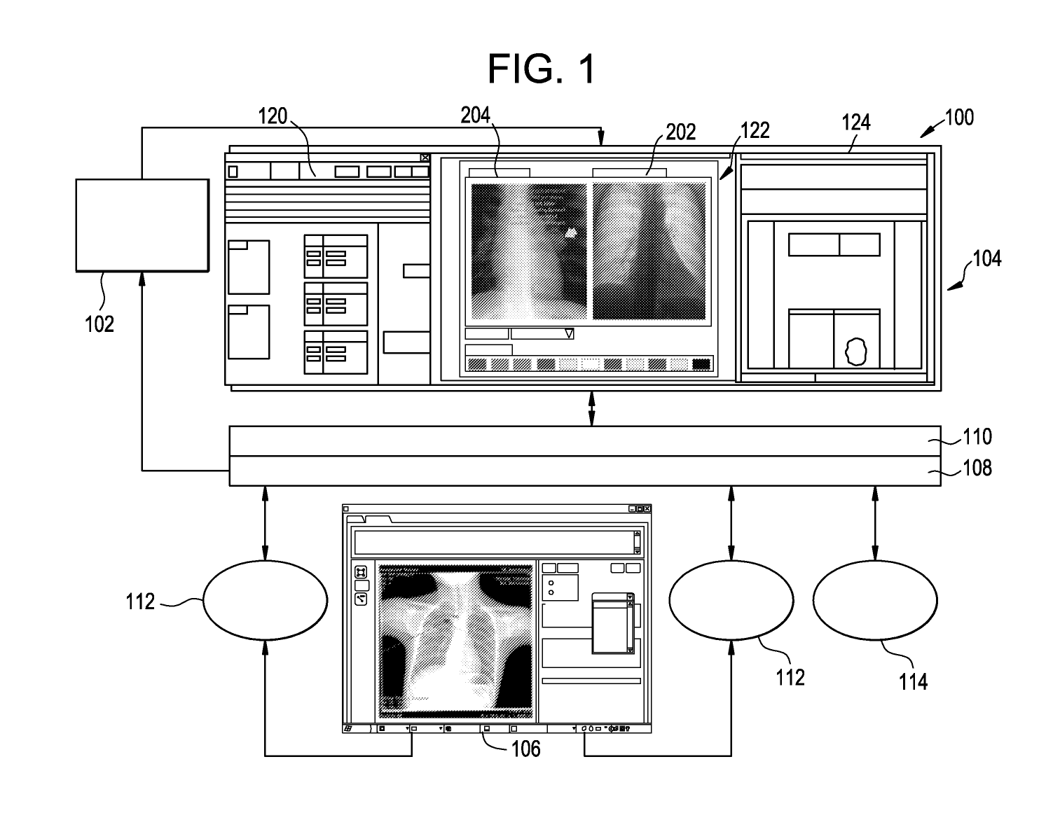

FIG. 1 depicts a medical data viewing system 100 used in accordance with embodiments of the present technology. The system 100 includes a database 102 comprising entries from previous medical studies. The entries can include image data and non-image data. The entries can include annotated medical information. The annotations can include comments and/or markings on images. Each entry can be associated with a category and sub-category, for example, that indicate clinical modality (for example, cardiology, oncology, muscleoskeletal, urology, neurology, etc.), imaging modality (for example, Computed Tomography (CT), Magnetic Resonance (MR), Nuclear Medical (NM), X-ray, Ultrasound, etc.), pathology (for example, tuberculin-skin test, sputum smear culture, etc.), etc. An entry can include data from a previous study that shows a normal anatomical condition or test result. An entry can include data from a previous study that shows an abnormal anatomical condition or test result.

The system 100 also includes a user interface 104 configured to display information from a current study and annotated information from a previous study, the previous study being identified in the database based on input information from the current study. For example, as discussed above, each previous study that has an entry in the database can be classified by category and sub-category. Likewise, a current study can be classified by category and sub-category. When the category and sub-category for the current study are input, previous studies with matching category and sub-category can be identified. In embodiments where information from a current study includes test results, annotated information from a previous study with similar or the same test results can be identified in the database.

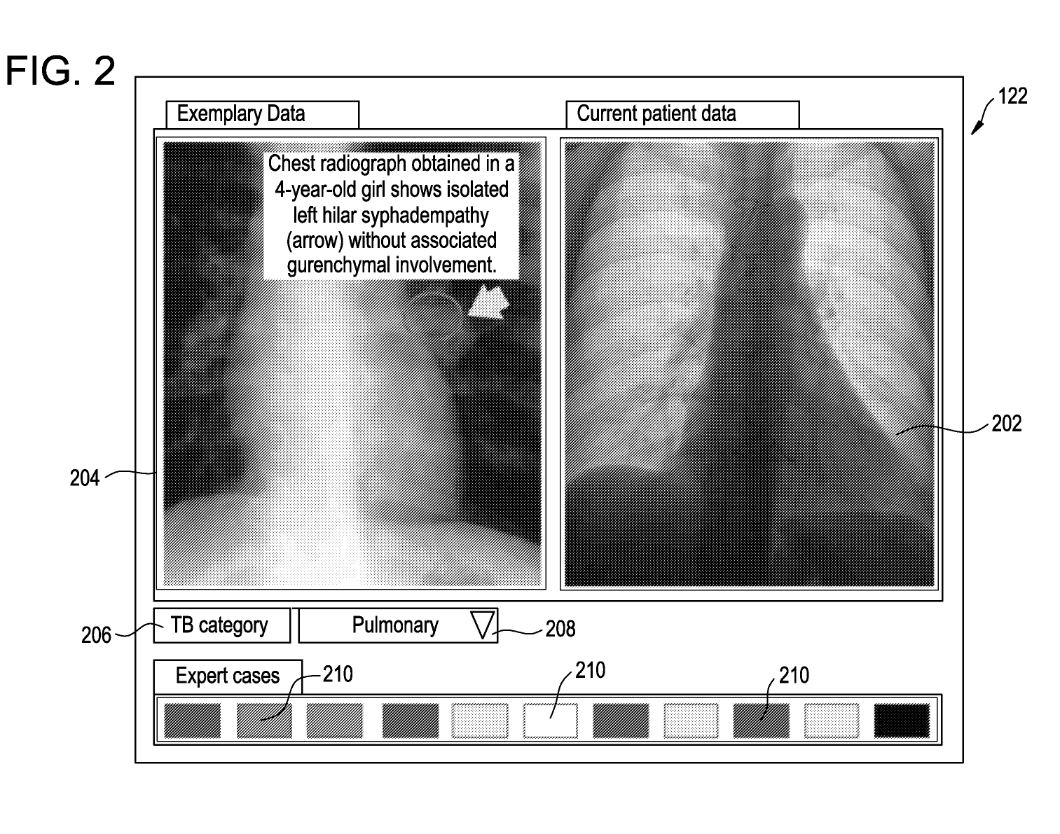

The user interface 104 includes a display area 122 (also depicted in FIG. 2) configured to display medical information 202 from the current study and annotated medical information 204 from the previous study. The annotated medical information 204 includes a marker (circle) indicating a portion of the displayed anatomy and a comment. The display area 122 also indicates a category 206 of tuberculosis (TB) and a sub-category 208 of pulmonary. The display area 122 also includes a plurality of thumbnails 210 associated with annotated medical information from other previous studies. Each of the thumbnails 210 can include an image, a comment and/or a synopsis of a comment. Each thumbnail can be associated with an entry in the database that is identified based on input information relating to the current study.

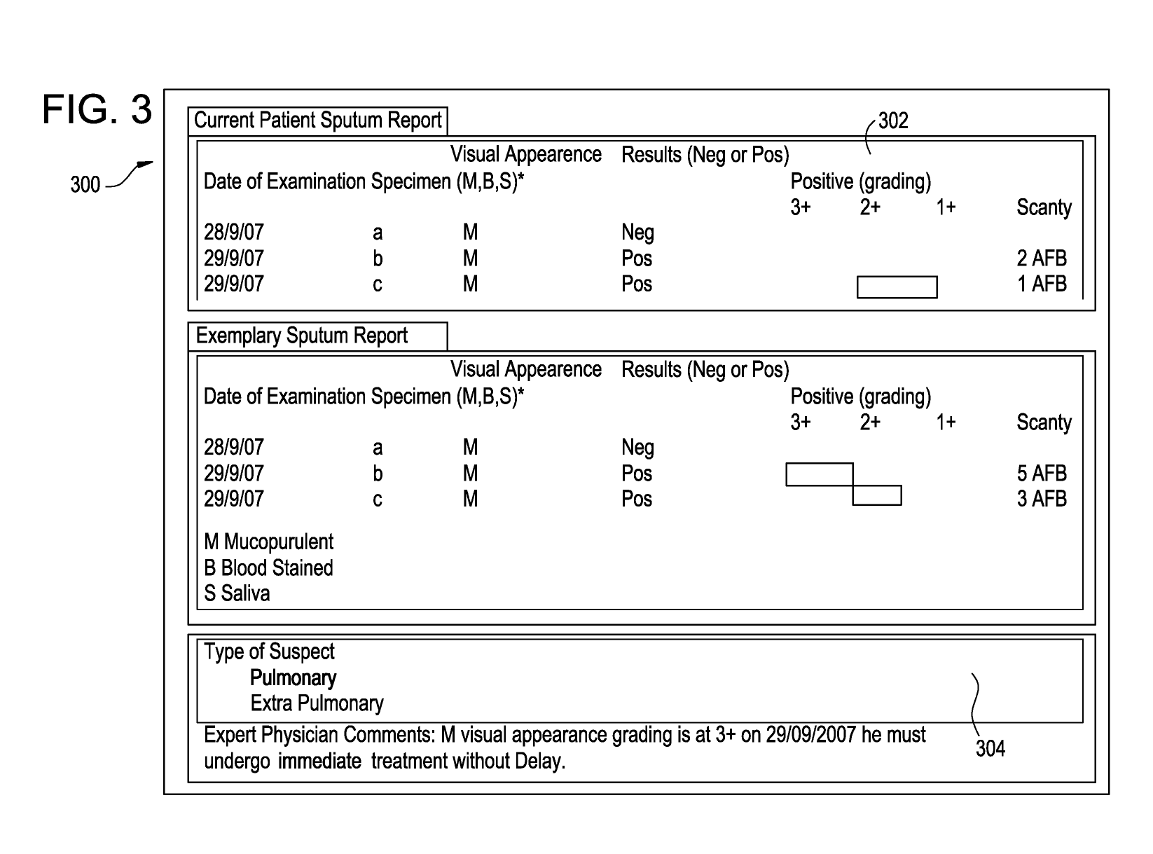

In certain embodiments, the user interface 104 includes a display area configured to display current and previous test results that do not include images. For example, FIG. 3 depicts a display area 300 that includes a current report 302 and an annotated previous report 304. Both reports could be in a category for pathology and a subcategory for pulmonary. Alternatively, a previous report could be identified as having the same (or similar) test results as the current report. Other annotated previous reports could be displayed as thumbnails in the display area 300.

The user interface 104 also includes a display area 120 configured to display a work list and case history for the current study. The work list has the list of procedures (scheduled and/or completed) for the patient involving multi-disciplinary clinical modalities. For example, the work-list may include Radiology modalities such as CT, Ultrasound, etc., and Pathology tests of stools & blood, images of tissue/sputum samples. The work-list also displays the patient's case history, which contains all the prior information that can assist the physician in the decision-making. For example, this may include the previous symptoms, diagnosis results, radiological and pathological information, suggested medication etc.

The user interface 104 also includes a display area 124 configured to display a clinical report. The clinical report would be a representation of the different reports generated from different clinical modalities or clinical departments. Selecting a completed task/procedure from the work-list will list the associated report. For example, selecting the pathology examination of a patient from the work-list will show the pathological images in the imaging area and the associated pathology report in the clinical report section.

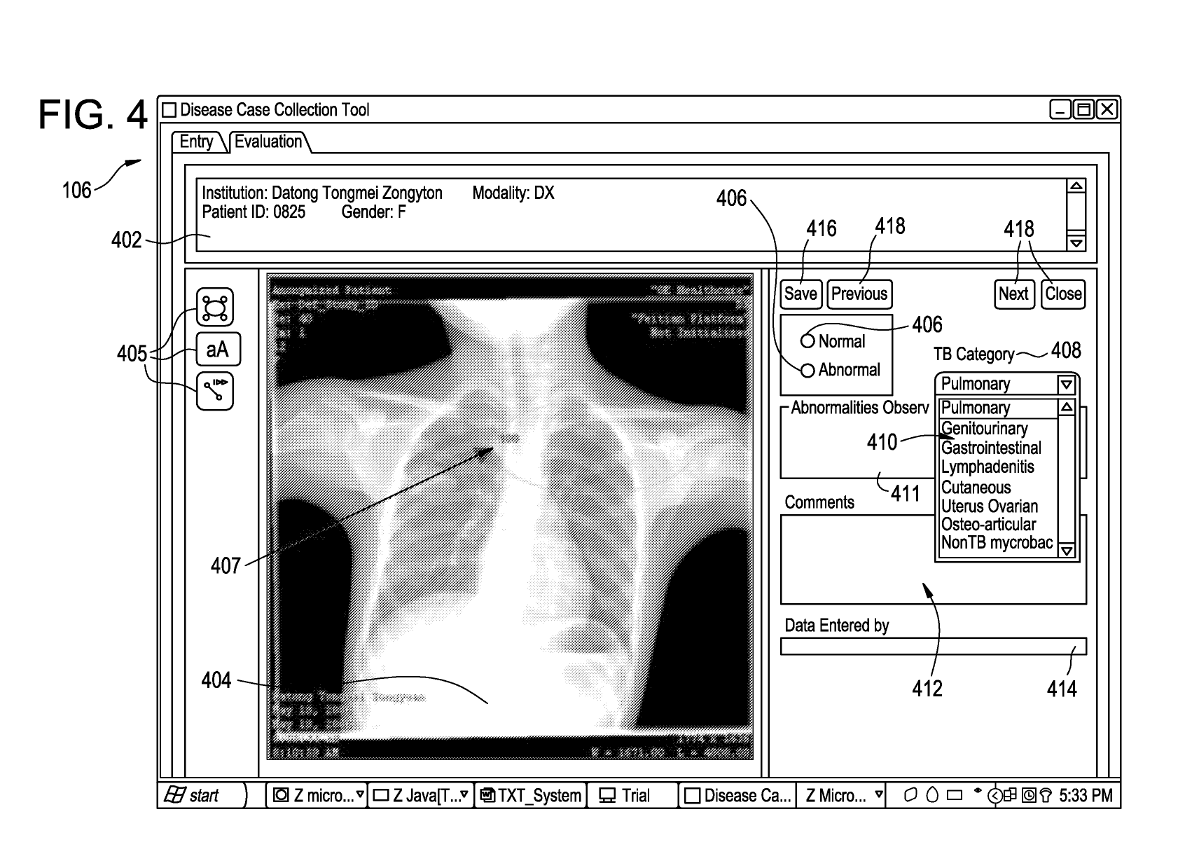

The system 100 also includes a user interface 106 (also depicted in FIG. 4) configured to display medical information, allow annotation of the medical information, and allow the annotated information to be saved as an entry in the database 102. The user interface 106 is configured to allow display, annotation and saving of an image depicting anatomy. The user interface 106 includes a display area 402 for displaying study information, for example, institution information (for example, where the study was performed), patient identification information (for example, number, name, etc.), patient gender, imaging modality, etc. The user interface 106 also includes a display area 404 configured to display an image depicting anatomy. The user interface 106 also includes drawing buttons 405, such as those that may be available in a drawing and/or text formatting toolbar, for example. The drawing buttons may allow an image to be marked by drawing shapes and/or text on the image. For example a circle 407 and the number 100 have been drawn on the depicted anatomy. The user interface 106 also includes radio buttons 406 that can allow the image to be indicated to depict normal anatomy or abnormal anatomy. The user interface 106 also includes a menu 408 that can allow a category to be selected or entered, and a menu 410 that can allow a sub-category to be selected or entered. The user interface 106 also includes a menu 411 that can allow observed abnormalities to be selected or entered. The user interface 106 also includes a comments field 412 that can allow comments to be entered. The user interface 106 also includes a field 414 that can allow a specialist's information to be entered. The user interface 106 also includes a save button 416 that can allow the annotated study to be saved. The user interface 106 also includes navigation buttons 418 that can allow a user to close the study or navigate to a previous or next study.

The database 102 and user interfaces 104, 106 are operably connected using a data integration framework 108 and information technology platform 110. In certain embodiments, the technology platform 110 can be a Viz platform. In operation, the system can allow data 112 to be communicated between the annotation interface 106 and the database 102. The system can also allow data 114 to be communicated between other sources and the database 102. The system can also allow data to be communicated between the display interface 104 and the database 102. The database 102 and user interfaces 104, 106 can be operably connected with a computer processor, thereby allowing information to be communicated between the database 102 and user interfaces 104, 106.

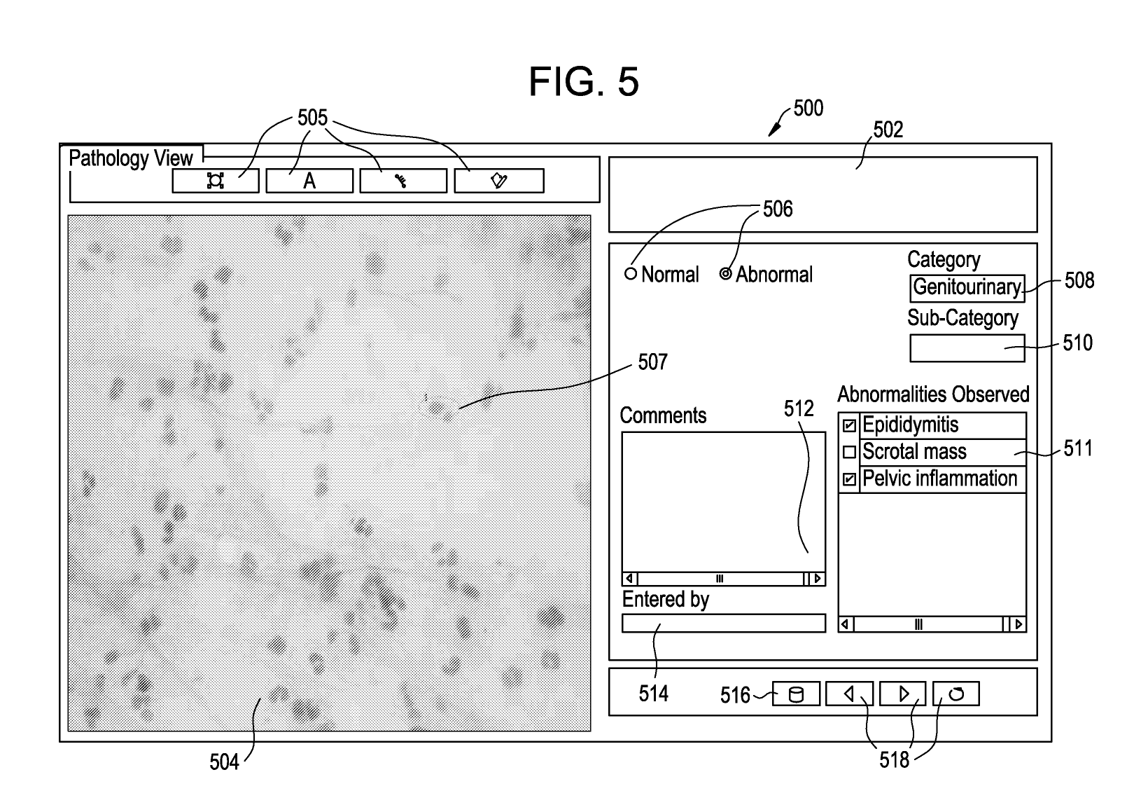

FIG. 5 depicts a user interface 500 configured to display medical information, allow annotation of the medical information, and allow the annotated information to be saved as an entry in the database 102. The user interface 500 is configured to allow display, annotation and saving of an image depicting pathology. In certain embodiments, the user interface 500 can be used in connection with a system as described in connection with FIG. 1 in place of or in addition to user interface 106. The user interface 500 includes a display area 502 for displaying study information, for example, institution information (for example, where the study was performed), patient identification information (for example, number, name, etc.), patient gender, imaging modality. The user interface 500 also includes a display area 504 configured to display an image depicting pathology. The user interface 500 also includes drawing buttons 505, such as those that may be available in a drawing and/or text formatting toolbar, for example. The drawing buttons may allow an image to be marked by drawing shapes and/or text on the image. For example a circle 507 has been drawn on the depicted pathology. The user interface 500 also includes radio buttons 506 that can allow the image to be indicated to depict normal pathology or abnormal pathology. The user interface 500 also includes a menu 508 that can allow a category to be selected or entered, and a menu 510 that can allow a sub-category to be selected or entered. The user interface 500 also includes a menu 511 that can allow observed abnormalities to be selected or entered. The user interface 500 also includes a comments field 512 that can allow comments to be entered. The user interface 500 also includes a field 514 that can allow a specialist's information to be entered. The user interface 500 also includes a save button 516 that can allow the annotated study to be saved. The user interface 500 also includes navigation buttons 518 that can allow a user to close the study or navigate to a previous or next study.

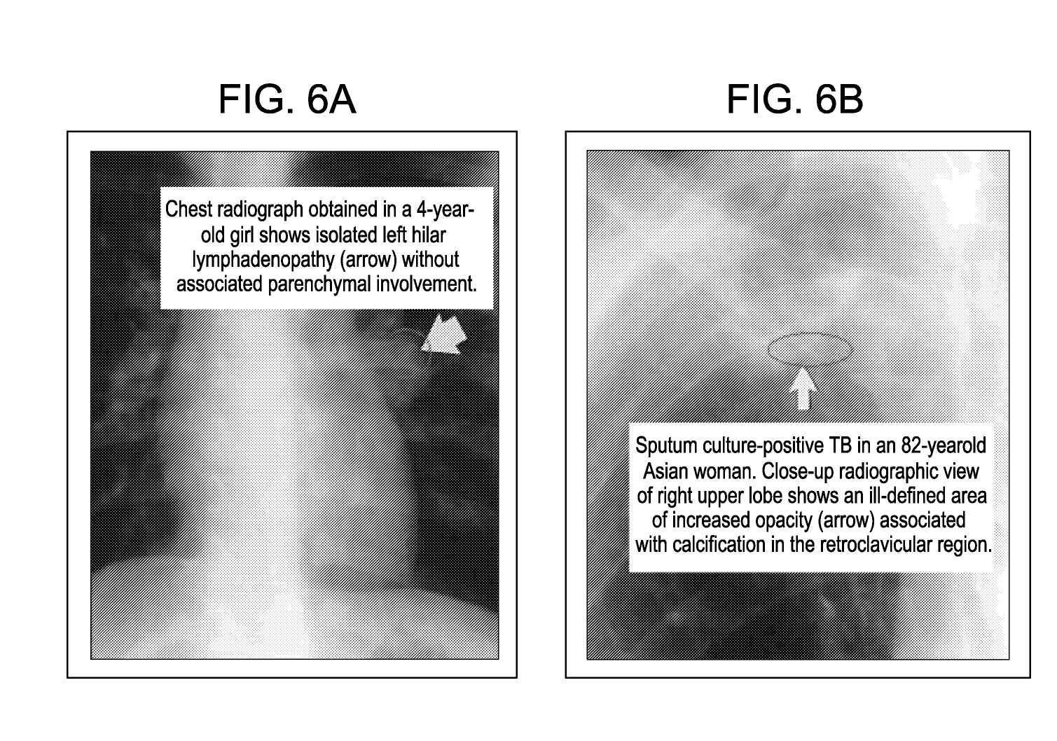

FIGS. 6A and 6B depict annotated images used in accordance with embodiments of the present technology. Each annotated image includes a circle and arrow indicating a portion of the imaged anatomy, and a comment. Such images could be classified as category tuberculosis and sub-category pulmonary.

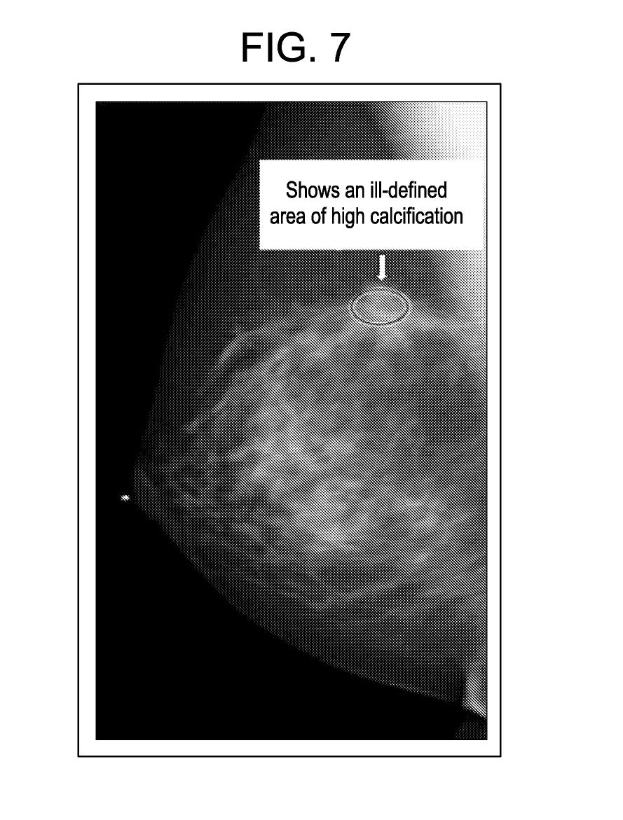

FIG. 7 depicts an annotated image used in accordance with embodiments of the present technology. The annotated image includes a circle and arrow indicating a portion of the imaged anatomy, and a comment. Such an image could be classified as category oncology and sub-category breast.

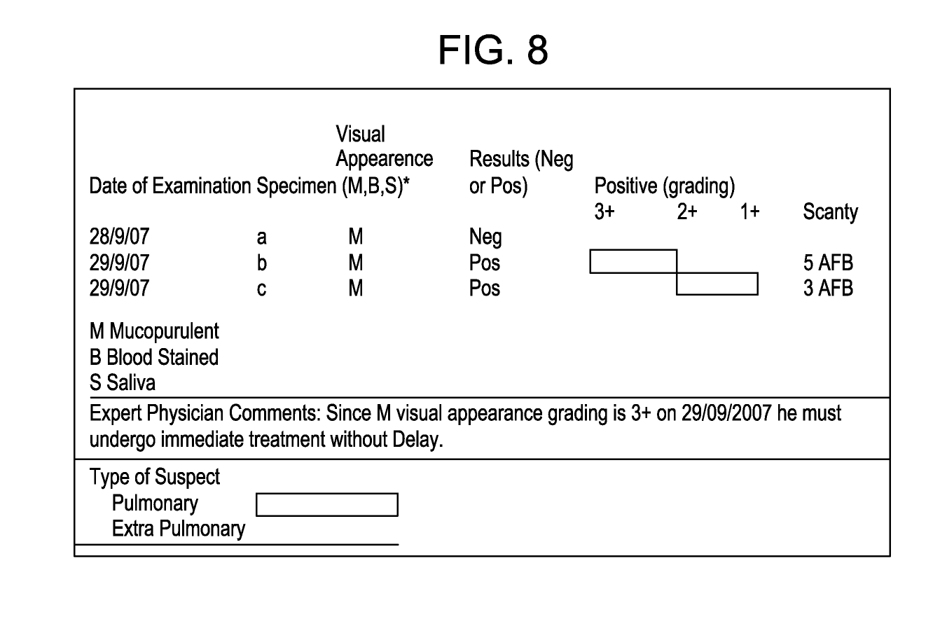

FIG. 8 depicts annotated test results used in accordance with embodiments of the present technology. The annotated results include a comment. Such test results could be classified as category tubercluosis and sub-category pulmonary.

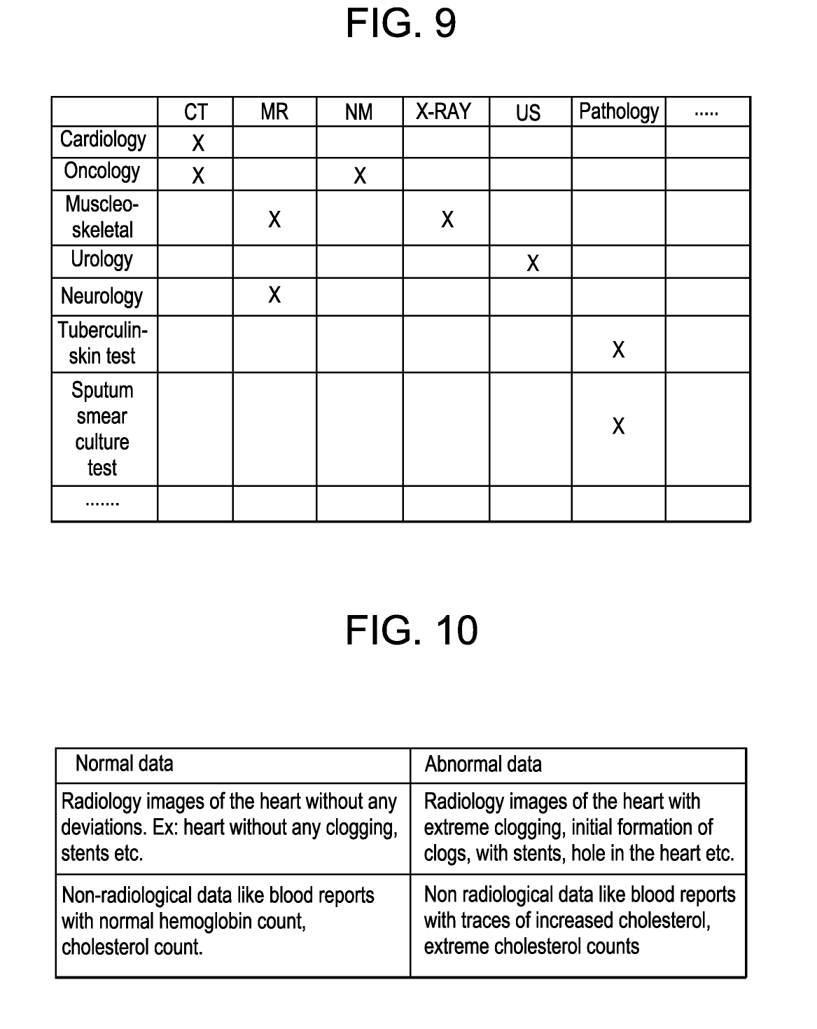

FIG. 9 depicts a database entry classification table used in accordance with embodiments of the present technology. The table includes categories: Computed Tomography (CT), Magnetic Resonance (MR), Nuclear Medical (NM), X-ray, Ultrasound (US), Pathology, etc. The table also includes sub-categories: cardiology, oncology, muscleoskeletal, urology, neurology, tuberculin-skin test, sputum smear culture, etc. the categories and sub-categories can be used to identify annotated previous studies in a database based on input information regarding a current study. In certain embodiments, different categories and/or sub-categories can be used or other categories and/or sub-categories can be included.

FIG. 10 provides types of database entry classification data used in accordance with embodiments of the present technology. The table includes normal data and abnormal data. The normal data includes image data (for example, radiology images of a heart without any deviations, such as a heart without any clogging, stents etc.) and non-image data (for example, blood reports with normal hemoglobin count, cholesterol count, etc.). The abnormal data includes image data (for example, radiology images of a heart with extreme clogging, initial formation of clogs, with stents, hole in the heart, etc.) and non-image data (for example, blood reports with traces of increased cholesterol, extreme cholesterol counts, etc.). Such previous studies could be classified as category (or sub-category) cardiology, and could be identified when information regarding a current study of category (or sub-category) cardiology is input.

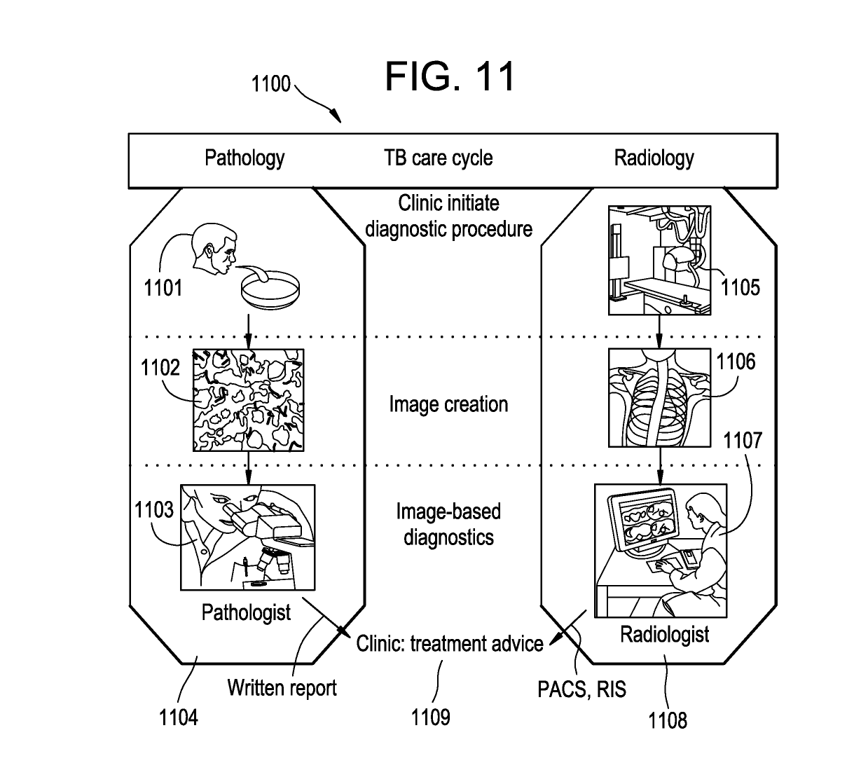

FIG. 11 depicts an example of a diagnosis workflow 1100 for a tuberculosis care cycle. Parallel efforts for pathology and radiology are commenced and the results provided to a clinician for a diagnosis based on such results. At 1101, sputum is collected from a patient. At 1102, the sputum is imaged. At 1103, a pathologist reviews the imaged sputum. At 1104, the pathologist provides a report to a clinician. Meanwhile, at 1105, the patient's anatomy is imaged. At 1106, the images are processed. At 1107, a radiologist reviews the imaged anatomy. At 1108, the radiologist provides a report to the clinician. At 1109, the clinician reviews the reports from the pathologist and the radiologist and makes a diagnosis. However, if a radiologist or pathologist is not available to provide analysis, a clinician may delay in making a diagnosis and beginning treatment. Embodiments of the present technology can allow a clinician to analyze such pathology and radiology data without requiring a pathologist or radiologist. In other words, embodiments of the present technology can improve the availability of specialized knowledge that can be used in diagnosing medical conditions.

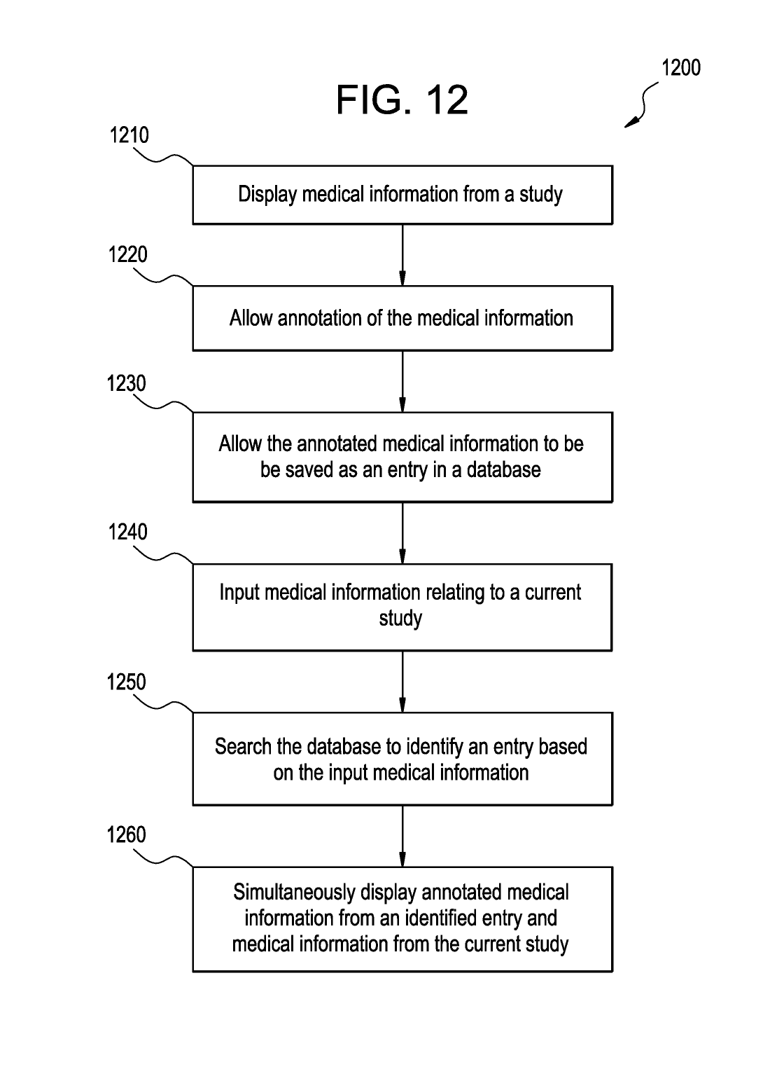

FIG. 12 depicts a flow chart for a medical data viewing method 1200 used in accordance with embodiments of the present technology. At 1210, medical information from a study is displayed. For example, medical information from a study can be displayed in a user interface such as those shown and described in FIGS. 4 and 5. At 1220, annotation of the medical information is allowed. For example, a user interface such as those shown and described in FIGS. 4 and 5 can allow a user to annotate the medical information with markings and/or comments. At 1230, saving of the annotated medical information as an entry in a database is allowed. For example, a user interface such as those shown and described in FIGS. 4 and 5 can allow the annotated medical information to be saved as an entry in a database, such as database 102 described herein. At 1240, medical information relating to a current study can be input. For example, image and/or non-image information can be input, such as category, sub-category and/or test result information, for example, can be input. At 1250, the database can be searched to identify an entry based on the input medical information. For example, a database entry with category and sub-category that matches the category and sub-category of the current study can be identified. At 1260, annotated medical information from an identified entry and medical information from the current study can be displayed simultaneously. For example, the information can be displayed using a user interface similar to that shown and described in FIG. 1.

Certain embodiments may omit one or more of these steps and/or perform the steps in a different order than the order listed. For example, some steps may not be performed in certain embodiments. As a further example, certain steps may be performed in a different temporal order, including simultaneously, than listed above.

One or more of the steps of the method 1200 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device. For example, certain embodiments provide a computer-readable storage medium encoded with a set of instructions for execution on a processing device and associated processing logic, wherein the set of instructions includes a routine(s) configured to provide the functions described in connection with the method 1200.

Applying the method 1200 as described above, and/or in light of the embodiments described herein, for example, as described in connection with FIGS. 1-11, can provide for improved availability of specialized knowledge that can be used in diagnosing medical conditions.

Certain embodiments of the technology described herein provide a technical effect of providing a database of annotated medical information from a plurality of clinical modalities, imaging modalities and/or pathologies. Certain embodiments of the technology described herein provide a technical effect of simultaneously displaying annotated medical information from an identified database entry and medical information from a current study in order to facilitate diagnosis of a medical condition.

Image data acquired, analyzed and displayed in connection with the embodiments disclosed herein represents human anatomy. In other words, outputting a visual display based on such data comprises a transformation of underlying subject matter (such as an article or materials) to a different state.

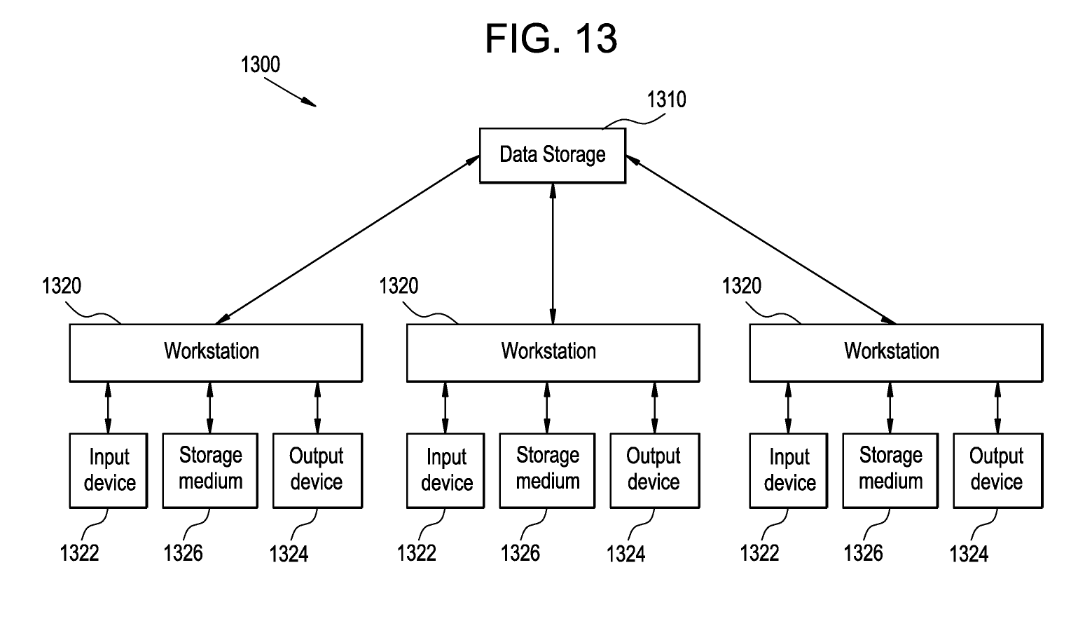

Certain embodiments of the medical data viewing systems and methods described herein may be implemented on a clinical information system, such as the system 1300 of FIG. 13. In certain embodiments, an interface including patient information and images may be viewed and/or constructed using a system such as system 1300 including at least one data storage 1310 and at least one workstation 1320. While three workstations 1320 are illustrated in system 1300, a larger or smaller number of workstations 1320 can be used in accordance with embodiments of the presently described technology. In addition, while one data storage 1310 is illustrated in system 1300, system 1300 can include more than one data storage 1310. For example, each of a plurality of entities (such as remote data storage facilities, hospitals or clinics) can each include one or more data stores 1310 in communication with one or more workstations 1320.

As illustrated in system 1300, one or more workstations 1320 can be in communication with at least one other workstation 1320 and/or at least one data storage 1310. Workstations 1320 can be located in a single physical location or in a plurality of locations. Workstations 1320 can be connected to and communicate via one or more networks.

Workstations 1320 can be directly attached to one or more data stores 1310 and/or communicate with data storage 1310 via one or more networks. Each workstation 1320 can be implemented using a specialized or general-purpose computer executing a computer program for carrying out the processes described herein. Workstations 1320 can be personal computers or host attached terminals, for example. If workstations 1320 are personal computers, the processing described herein can be shared by one or more data stores 1310 and a workstation 1320 by providing an applet to workstation 1320, for example.

Workstations 1320 include an input device 1322, an output device 1324 and a storage medium 1326. For example, workstations 1320 can include a mouse, stylus, microphone and/or keyboard as an input device. Workstations 1320 can include a computer monitor, liquid crystal display (“LCD”) screen, printer and/or speaker as an output device.

Storage medium 1326 of workstations 1320 is a computer-readable memory. For example, storage medium 1326 can include a computer hard drive, a compact disc (“CD”) drive, a USB thumb drive, or any other type of memory capable of storing one or more computer software applications. Storage medium 1326 can be included in workstations 1320 or physically remote from workstations 1320. For example, storage medium 1326 can be accessible by workstations 1320 through a wired or wireless network connection.

Storage medium 1326 includes a set of instructions for a computer. The set of instructions includes one or more routines capable of being run or performed by workstations 1320. The set of instructions can be embodied in one or more software applications or in computer code.

Data storage 1310 can be implemented using a variety of devices for storing electronic information such as a file transfer protocol (“FTP”) server, for example. Data storage 1310 includes electronic data. For example, data storage 1310 can store patient exam images and/or other information, electronic medical records, patient orders, etc., for a plurality of patients. Data storage 1310 may include and/or be in communication with one or more clinical information systems, for example.

Communication between workstations 1320, workstations 1320 and data storage 1310, and/or a plurality of data stores 1310 can be via any one or more types of known networks including a local area network (“LAN”), a wide area network (“WAN”), an intranet, or a global network (for example, Internet). Any two of workstations 1320 and data stores 1310 can be coupled to one another through multiple networks (for example, intranet and Internet) so that not all components of system 1300 are required to be coupled to one another through the same network.

Any workstations 1320 and/or data stores 1310 can be connected to a network or one another in a wired or wireless fashion. In an example embodiment, workstations 1320 and data store 1310 communicate via the Internet and each workstation 1320 executes a user interface application to directly connect to data store 1310. In another embodiment, workstation 1320 can execute a web browser to contact data store 1310. Alternatively, workstation 1320 can be implemented using a device programmed primarily for accessing data store 1310.

Data storage 1310 can be implemented using a server operating in response to a computer program stored in a storage medium accessible by the server. Data storage 1310 can operate as a network server (often referred to as a web server) to communicate with workstations 1320. Data storage 1310 can handle sending and receiving information to and from workstations 1320 and can perform associated tasks. Data storage 1310 can also include a firewall to prevent unauthorized access and enforce any limitations on authorized access. For instance, an administrator can have access to the entire system and have authority to modify portions of system 1300 and a staff member can only have access to view a subset of the data stored at data store 1310. In an example embodiment, the administrator has the ability to add new users, delete users and edit user privileges. The firewall can be implemented using conventional hardware and/or software.

Data store 1310 can also operate as an application server. Data store 1310 can execute one or more application programs to provide access to the data repository located on data store 1310. Processing can be shared by data store 1310 and workstations 1320 by providing an application (for example, a java applet). Alternatively, data store 1310 can include a stand-alone software application for performing a portion of the processing described herein. It is to be understood that separate servers may be used to implement the network server functions and the application server functions. Alternatively, the network server, firewall and the application server can be implemented by a single server executing computer programs to perform the requisite functions.

While the inventions herein have been described with reference to embodiments, it will be understood by those skilled in the art that various changes may be made and equivalents may be substituted without departing from the scope of the inventions. In addition, many modifications may be made to adapt a particular situation or material to the teachings of the inventions without departing from their scope. Therefore, it is intended that the inventions not be limited to the particular embodiments disclosed, but that the inventions will include all embodiments falling within the scope of the appended claims.

1. A system for viewing medical data comprising:
a computer processor operably connected to a database and a user interface,
the database including a plurality of entries from a plurality of clinical modalities, each entry including at least one of image data and a non-image data, each entry including annotated medical information from a previous study, the annotated medical information including at least one of comments and markings, the database searchable to identify an entry based on input medical information relating to a current study, and
the user interface configured to simultaneously display annotated medical information from an identified entry and medical information from the current study.

2. The system of claim 1, further comprising a second user interface operably connected to the processor and the database, the second user interface configured to display medical information from a study, allow a user to annotate the medical information, and allow the user to save the annotated medical information as an entry in the database.

3. The system of claim 2, wherein the second user interface is configured to allow a user to classify the study with a category and a sub-category.

4. The system of claim 2, wherein the second user interface is configured to allow a user to classify the study as normal or abnormal.

5. The system of claim 1, wherein the input medical information is a category and a sub-category.

6. The system of claim 1, wherein the user interface is configured to display a plurality of thumbnails associated with other database entries that are also identified based on the input medical information.

7. The system of claim 1, wherein the displayed annotated medical information includes a database entry classified as normal and a database entry classified as abnormal.

8. The system of claim 1, wherein the displayed annotated medical information includes a database entry classified as a first clinical modality and a database entry classified as a second clinical modality, wherein both entries include both image data and non-image data.

9. A method for viewing medical data comprising:
inputting medical information relating to a current study;
using a computer processor to search a database including a plurality of entries from a plurality of clinical modalities to identify an entry based on the input medical information, each entry including at least one of image data and a non-image data, each entry including annotated medical information from a previous study, the annotated medical information including at least one of comments and markings; and
using a user interface to simultaneously display annotated medical information from an identified entry and medical information from the current study.

10. The method of claim 9, further comprising using a second user interface operably connected to the processor and the database to display medical information from a study, allow annotation of the medical information, and allow the annotated medical information to be saved as an entry in the database.

11. The method of claim 10, wherein the second user interface is configured to allow a user to classify the study with a category and a sub-category.

12. The method of claim 10, wherein the second user interface is configured to allow a user to classify the study as normal or abnormal.

13. The method of claim 9, wherein the input medical information is a category and a sub-category.

14. The method of claim 9, wherein the user interface is configured to display a plurality of thumbnails associated with other database entries that are also identified based on the input medical information.

15. The method of claim 9, wherein the displayed annotated medical information includes a database entry classified as normal and a database entry classified as abnormal.

16. The method of claim 9, wherein the displayed annotated medical information includes a database entry classified as a first clinical modality and a database entry classified as a second clinical modality, wherein both entries include both image data and non-image data.

17. A computer-readable storage medium encoded with a set of instructions for execution on a processing device and associated processing logic, wherein the set of instructions includes:
a first routine configured to allow medical information relating to a current study to be input;
a second routine configured to allow a database including a plurality of entries from a plurality of clinical modalities to be searched to identify an entry based on the input medical information, each entry including image data and a non-image data, each entry including annotated medical information from a previous study, the annotated medical information including comments and markings; and
a third routine configured to provide for simultaneous display of annotated medical information from an identified entry and medical information from the current study.

18. The computer-readable storage medium encoded with a set of instructions of claim 17, further comprising:
a fourth routine configured to provide for display of medical information;
a fifth routine configured to allow annotation of the medical information; and
a sixth routine configured to allow the annotated medical information to be saved as an entry in the database.

19. The computer-readable storage medium encoded with a set of instructions of claim 17, further including a seventh routine configured to allow classification of the entry with a category and a sub-category.

20. The computer-readable storage medium encoded with a set of instructions of claim 18, further including an eighth routine configured to allow classification of the entry as normal or abnormal.

21. The computer-readable storage medium encoded with a set of instructions of claim 18, wherein the input medical information is a category and a sub-category.

22. The computer-readable storage medium encoded with a set of instructions of claim 17, wherein the third routine is configured to provide for display of a plurality of thumbnails associated with other database entries that are also identified based on the input medical information.

23. The computer-readable storage medium encoded with a set of instructions of claim 17, wherein the third routine is configured to provide for display of annotated information from a database entry classified as normal and annotated information from a database entry classified as abnormal.

24. The computer-readable storage medium encoded with a set of instructions of claim 17, wherein the third routine is configured to provide for display of annotated information from a database entry classified as a first clinical modality and a database entry classified as a second clinical modality, wherein both entries include both image data and non-image data.
